(19) United States
(12) Patent Application Publication
(10) Pub. No.: US 2003/0028462 A1
(43) Pub. Date: Feb. 6, 2003

(54) Method for identifying comparable instruments

(76) Inventors: Robert N. Fuhrman, Ridgewood, NJ (US); Benjamin Ho, Morristown, NJ (US)

Correspondence Address: Clifford Chance Rogers & Wells LLP, 200 Park Avenue, New York, NY, 10166-0153, US

(21) Appl. No.: 09/997,085

(22) Filed: Nov. 29, 2001

Related U.S. Application Data
(60) Provisional application No. 60/288,367, filed on May 3, 2001.

(51) Int. Cl. G06F 17/60

(52) U.S. Cl. 705/36

(57) ABSTRACT

A method for determining the comparability of at least two bonds is provided and includes the steps of identifying a plurality of factors and determining a value for each of said plurality of factors for each of the at least two bonds. Next, a covariance matrix is formed where the covariance matrix includes a weighting factor for each of the plurality of factors and where each of the weighting factors relate to an amount of market activity attributed to the corresponding one of the plurality of factors. Finally, the comparability of the at least two bonds is determined based on the values for each of the at least two bonds and the covariance matrix.

### CROSS-REFERENCE TO RELATED APPLICATION

This application claims the benefit of the filing date of U.S. Provisional Application serial No. 60/288,367 entitled “A METHOD FOR COMPARING BONDS,” which was filed on May 3, 2001.

### BACKGROUND

The following invention relates to a method for evaluating financial instruments and, in particular, to a method for determining the comparability of bonds.

Identifying comparable securities is often desirable when managing financial assets. For example, knowing which securities are comparable is useful for adjusting the components in a portfolio, pricing a new issue, analyzing the behavior of different market segments and implementing various trading strategies.

Generally, two securities are “comparable” if their market behavior is similar. In the context of fixed income instruments, for example, two instruments are deemed “comparable” if there is a stable relationship between their asset swap spreads (i.e., the spread between the instrument's yield and LIBOR) under different market conditions. In other words, two bonds are comparable if their historical spreads have moved concurrently.

Although historical spread correlation is the generally accepted benchmark for determining whether two bonds are comparable, there are several problems in using such a benchmark for comparability. First, because statistical correlation is based solely on the historical performance of the bonds being compared, the results do not necessarily reflect market factors that may affect future performance of the bonds. Also, a substantial amount of accurate historical data is required to determine whether past similar behavior of two instruments is either a result of comparability or is merely a coincidence. For many bond issues, sufficient historical data is not available to reliably make this determination. In particular, for newly issued bonds there is no historical data upon which to base such a comparability determination. Furthermore, comparability based only on historical spread correlation gives no insight as to why comparable bonds move in a particular way and whether the bonds are exposed to similar risk factors.

Accordingly, it is desirable to provide a method for identifying comparable bonds based on market risk factors.

### SUMMARY OF THE INVENTION

The present invention is directed to overcoming the drawbacks of the prior art. Under the present invention a method is for determining the comparability of at least two bonds is provided and includes the step of identifying a plurality of factors and determining a value for each of said plurality of factors for each of the at least two bonds. Next, a covariance matrix is formed where the covariance matrix includes a weighting factor for each of the plurality of factors and where each of the weighting factors is an amount of market activity attributed to the corresponding one of the plurality of factors. Finally, the comparability of the at least two bonds is determined based on the values for each of the at least two bonds and the covariance matrix.

In an exemplary embodiment, the values for the plurality of factors for each of the at least two bonds include sector information, bond rating information, a duration and a time to maturity.

In another exemplary embodiment, the values include an issuer country, a put schedule, a coupon rate, an asset swap spread and whether each of said at least two bonds is a call bond and a sinking fund bond.

In yet another exemplary embodiment, the market activity is price changes in the market for a previous week.

In still yet another exemplary embodiment, the comparability is determined according to:

$$\frac{{f}_{1}^{′} Ω {f}_{2}}{\sqrt{{f}_{1}^{′} Ω {f}_{1} {f}_{2}^{′} Ω {f}_{2}}}$$

where f₁ are the values for the plurality of factors for a first of said at least two bonds, f₂ are the values for the plurality of factors for a second of the at least two bonds and Ω is the covariance matrix.

In an exemplary embodiment, comparability is determined according to:

(f₁−f₂)′Ω(f₁−f₂)

where f₁ are the values for the plurality of factors for a first of the at least two bonds, f₂ are the values for the plurality of factors for a second of the at least two bonds and Ω is the covariance matrix.

In another exemplary embodiment, the covariance matrix is tuned by adjusting the weighting factor for at least one of the plurality of factors.

According to the present invention, a method for determining the comparability of a primary bond and each of a list of bonds is provided and includes the step of identifying a plurality of factors and determining a value for each of the plurality of factors for the primary bond and for the each of the list of bonds. Next, a covariance matrix is formed where the covariance matrix includes a weighting factor for each of the plurality of factors and where each of the weighting factors is an amount of market activity attributed to the corresponding one of the plurality of factors. Finally, the comparability of the primary bond and the each of the list of bonds is determined based on the values for the primary bond, the values for the each of the list of bonds and the covariance matrix.

According to the present invention, a method for determining the comparability of a portfolio of bonds and an index bonds is provided and includes the step of identifying a plurality of factors, determining a value for each of the plurality of factors for the portfolio of bonds and determining a value for each of the plurality of factors for the index of bonds. Next, a covariance matrix is formed where the covariance matrix includes a weighting factor for each of the plurality of factors and where each of the weighting factors is an amount of market activity attributed to the corresponding one of the plurality of factors. Finally, the comparability of the portfolio of bonds and the index of bonds is determined based on the values for the primary bond, the values for the each of the list of bonds and the covariance matrix.

According to the present invention, computer executable program code residing on a computer-readable medium is provided and includes program code comprising instructions for causing the computer to identify a plurality of factors; determine a value for each of the plurality of factors for each of the at least two bonds; form a covariance matrix, the covariance matrix including a weighting factor for each of the plurality of factors wherein each of the weighting factors is an amount of market activity attributed to the corresponding one of the plurality of factors and determine the comparability of the at least two bonds based on the values for each of the at least two bonds and the covariance matrix.

According to the present invention, a system for determining the comparability of at least two bonds is provided and includes a factor vector generator for identifying a plurality of factors and determining a value for each of the plurality of factors for each of the at least two bonds. Also included is a covariance matrix generator for forming a covariance matrix that includes a weighting factor for each of the plurality of factors where each of the weighting factors is an amount of market activity attributed to the corresponding one of the plurality of factors. A comparability calculator is also included for receiving from the factor vector generator the values for each of the plurality of factors for each of the at least two bonds, for receiving the covariance matrix from the covariance matrix generator and for determining the comparability of the at least two bonds based on the values for each of the at least two bonds and the covariance matrix.

In an exemplary embodiment, the comparability generator determines comparability according to:

$$\frac{{f}_{1}^{′} Ω {f}_{2}}{\sqrt{{f}_{1}^{′} Ω {f}_{1} {f}_{2}^{′} Ω {f}_{2}}}$$

where f₁ are the values for the plurality of factors for a first of the at least two bonds, f₂ are the values for the plurality of factors for a second of the at least two bonds and Q is the covariance matrix.

In another exemplary embodiment, the comparability generator determines the comparability according to:

(f₁−f₂)′Ω(f₁−f₂)

where f₁ are the values for the plurality of factors for a first of the at least two bonds, f₂ are the values for said plurality of factors for a second of the at least two bonds and Ω is the covariance matrix.

In yet another exemplary embodiment, the factor vector generator identifies the plurality of factors and determines the value for each of the plurality of factors for each of the at least two bonds based on market information. Also, the covariance matrix generator forms the covariance matrix based on market information. The market information includes historical market price data, historical asset-swap spreads, sector information, bond rating information, bond duration and time to maturity. Accordingly, a method and system is provided for determining the comparability of bonds based on market risk factors.

The invention accordingly comprises the features of construction, combination of elements and arrangement of parts that will be exemplified in the following detailed disclosure, and the scope of the invention will be indicated in the claims. Other features and advantages of the invention will be apparent from the description, the drawings and the claims.

### DESCRIPTION OF THE DRAWINGS

For a fuller understanding of the invention, reference is made to the following description taken in conjunction with the accompanying drawings, in which:

FIG. 1 is a flow chart of a method for determining the comparability of a pair of bonds;

FIG. 2 is a flow chart of a method for determining the comparability of a list of bonds to a primary bond; and

FIG. 3 is a block diagram of a system for determining the comparability of bonds.

### DETAILED DESCRIPTION OF THE PREFERRED EMBODIMENTS

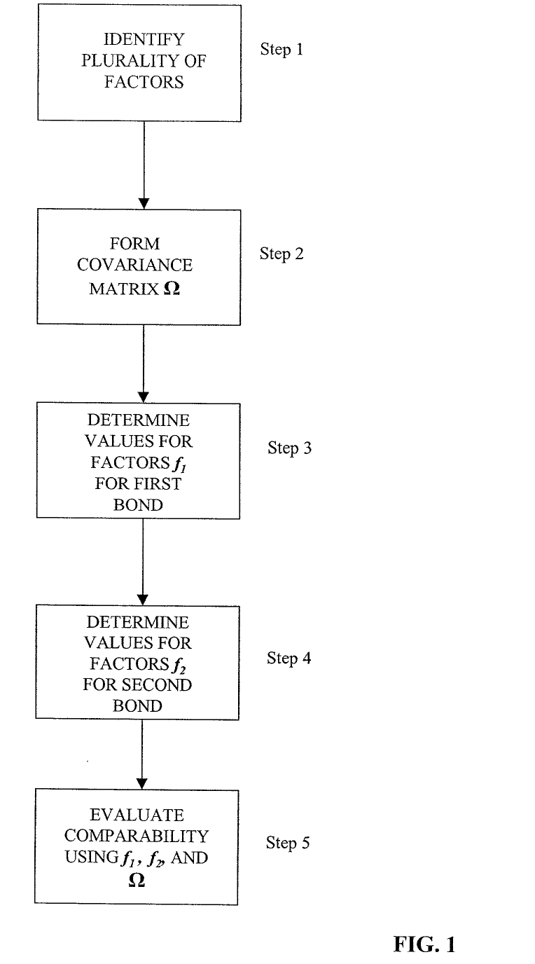

Referring now to FIG. 1, there is shown a flow chart of the method for determining the comparability of a pair of bonds. According to the present invention, two bonds are comparable if they share the same risks. Because the identity of a bond is captured in the bond's spread (i.e., its yield in excess of a benchmark yield, such as LIBOR), the determination of whether two bonds share the same risks is dependent on whether each of their respective spreads behave similarly given certain market factors and risks.

Initially, in Step 1, a plurality of factors that affect the spread of a bond is identified. An overall change in the spread of a bond may be partitioned into individual changes that are caused by specific market factors and risks. For example, if a particular bond is in the Telecommunications sector and the Telecommunications sector falls in disfavor, then a certain portion of a change in spread of the particular bond will result from its belonging to that sector. Similarly, other market factors exist that may contribute to the overall change in spread and include, by way of non-limiting example, the bond's rating, maturity/duration, issuer country, asset swap spread, coupon rate, put, call and sinking fund schedules.

The amount a spread may change based on a particular market factor is indicated by a corresponding weighting factor that represents the magnitude of the movement in the market over a period of time due to that particular factor. Any period of time may be used to measure market activity in order to determine the weighting factor. In a preferred embodiment, the period of time used to measure market activity is in the range of one week to one year. In an exemplary embodiment, the weighting factors are updated monthly. The market information used to derive the weighting factors includes all relevant bond information including, by way of non-limiting example, historical market price data, historical asset-swap spreads, sector information, bond rating information, bond duration and time to maturity.

The weighting factors are derived from historical data relating to the movement of bond spreads generally as a function of particular market factors over time. In an exemplary embodiment, a standard Ordinary Least Square (OLS) regression analysis is applied to the historical data to find the weighting factors by regressing the weighting factors onto the spread movements. The process of gathering historical data relating to spread movements and performing an OLS regression analysis is continuously repeated to capture the changes in weighting factors over time. In an exemplary embodiment, the process is repeated weekly for six months to provide the weighting factors to be used to form the covariance matrix. The covariance matrix is then formed from the changes in weighting factors, as described above.

Generalizing the above, the change in spread of a given bond, i, at time, t, is defined by the following linear first-order relationship:

ΔSpread_{i,t}=wₜ₀+wₜ₁ƒᵢ₁+wₜ₂ƒᵢ₂+w₃ƒᵢ₃+. . .+wₜₙƒᵢₙ+ε_{i,t} (2)

or

ΔSpread_{i,t}=wₜ₀+wₜ·fᵢ+ε_{i,t} (3)

where fᵢ is a vector containing values for n market factors. These values may be 0 or 1 in cases where the market factor is inclusion in a particular class (for example, the issuer country being the U.S.), as well as any number that represents a factor that influences the spread of a particular bond. An example of such factor is the coupon amount of a bond minus the average coupon amount for all bonds and the value of such factor for a particular bond is included in the vector fᵢ. The term wₜ is a vector containing a plurality of corresponding weighting factors each factor having a dimension in basis points (i.e., a change in spread). Alternatively, equation (3) may be recast in terms of return in which the weighting factors have a dimension in associated with a change in return. Finally, the term ε_{i,t} is portion of the change in spread that cannot be explained by these factors (that is assumed to be independent and normally distributed).

Thus, each wₜƒᵢ pair represents the magnitude of a change in spread at time, t, for a given bond, i, due to a given factor ƒ. For example, if a particular factor is whether a bond is BBB rated, then ƒₓ for that particular bond is 1 if the bond is BBB rated and 0 otherwise. If it is determined that over a given time period, for example, a week, spreads of BBB bonds widened by 5 bp, then the corresponding weighting factor wₓ for market factor ƒₓ is 5 bp. The wₓƒₓ term in equation (2) would then represent a 5 bp change in spread if that bond were BBB, and 0 otherwise.

Thus, while fᵢ is a vector of market factors that represent the observable characteristics of a specific bond i that is invariant over time, wₜ is a vector of weighting factors that are estimates on movements associated with the plurality of market factors in a given market for a given period of time. Consequently, changes over time in the weighting factors wₜ represent changes in the market associated with the plurality of factor fᵢ, respectively.

Next, in Step 2, a covariance matrix is formed that represents the risks contained in the market for a given period of time. As described above, bonds are comparable to the extent that each bond's return, defined as:

$$\begin{matrix}{Return}_{i , t}^{spread} = - {D}_{{mod}_{i}} \cdot Δ {Spread}_{i , t} \\ = - {D}_{{mod}_{i}} ( {w}_{t0} + {w}_{t} \cdot {f}_{i} + {ϵ}_{i , t} ) \\ = {w}_{t}^{′} + {w}_{t} \cdot {f}_{i}^{′} + {ϵ}_{i , t}^{′}\end{matrix} \qquad ( 4 )$$

(where −D_{modi} is the negative modified duration of bond I, wₜ₀ is a drift term representing systematic changes in spread unrelated to weighting factors wₜ, and ε_{i,t} is a portion of the changes in spread that cannot be explained by weighting factors wₜ) is similarly affected by exposure to market risks. In this context, a particular bond's exposure to risk may be defined as the standard deviation, δ(R), of the particular bond's returns over time, R, so that:

Risk(R_{i,t})=δ(R_{i,t})=δ(w_{0i,t}+wₜ·fᵢ+ε_{i,t}) (5)

By identifying the observable characteristics with respect to a plurality of factors for the particular bond (fᵢ) and estimating the corresponding weighting factors (wₜ), Equation (5) can thus be used to identify and quantify the sources of risks affecting the yield of a particular bond. For example, to determine whether the credit rating of a particular bond is a source of risk affecting the bond's yield and, if so, the magnitude of such risk, Risk (R_{i,t}) of Equation (5) is calculated twice: once by including in wₜ the weighting factor associated with credit rating and a second time by setting the credit rating weighting factor to zero. If the risk resulting from each calculation is substantially the same, the credit rating has little impact on the risk associated with the particular bond. If, however, the two calculations differ, then credit rating does have an impact on the risk of the bond and the magnitude of such risk is indicated by the magnitude of the difference between the calculations.

For example, assume that a particular pair of bonds, a WCOM 8.250 05/15/10 bond and a GS 7.800 01/28/10 bond, has a comparability score (defined as how closely the spreads of each of the pair of bonds move together) of 0.0282796. To determine the source of the relative lack of comparability between the two bonds, the weighting for sector is set to zero to determine the comparability of the two bonds as a function of market factors other than sector. Assume next that with the sector weighting factor set to zero, the comparability score between the two bonds improves significantly to 0.0082796. The inference from the increase in comparability score is that the primary source of the lack of comparability between the WCOM bond and the GS bond is that WCOM is in the telecommunication sector and GS is in the banking sector. We thus conclude that the source of the differences between the GS bond and the WCOM bond derives largely, but not completely from the differences in sector.

Furthermore, the variance of a bond's return (ignoring the constant term and the error term for simplicity) is δ²(R). For example, if there are only two factors in a model of returns for a particular bond, then the Return R is

$$R = {f}_{1} {w}_{1} + {f}_{2} {w}_{2} \\ and , \\ \begin{matrix}{σ}^{2} ( R ) = {σ}^{2} ( {f}_{1} {w}_{1} + {f}_{2} {w}_{2} ) \\ = {σ}^{2} ( {f}_{1} {w}_{1} ) + 2 \cdot Cov ( {f}_{1} {w}_{1} , {f}_{2} {w}_{2} ) + {σ}^{2} ( {f}_{2} {w}_{2} )\end{matrix} \\ Thus , because {f}_{1} and {f}_{2} are constants , \\ \begin{matrix}= {f}_{1}^{2} {σ}^{2} ( {w}_{1} ) + 2 {f}_{1} {f}_{2} Cov ( {w}_{1} , {w}_{2} ) + {f}_{2}^{2} {σ}^{2} ( {w}_{2} ) \\ = [ \begin{matrix}{f}_{1} & {f}_{2}\end{matrix} ] [ \begin{matrix}{σ}^{2} ( {w}_{1} ) & Cov ( {w}_{1} , {w}_{2} ) \\ Cov ( {w}_{1} , {w}_{2} ) & {σ}^{2} ( {w}_{2} )\end{matrix} ] [ \begin{matrix}{f}_{1} \\ {f}_{2}\end{matrix} ]\end{matrix} \qquad ( 6 )$$

The matrix in the middle having a diagonal of variances, and every other element i,j being equal to Cov(wᵢ, wⱼ), is the covariance matrix with respect to w, Ω(w), or simply Ω. Although the covariance matrix of Equation 6 includes only two weighting factors, it will be further obvious to derive a covariance matrix for a bond model that includes any number of weighting factors w. It follows then that the covariance between any two bonds, represented by factor vectors, f₁ and f₂, is:

$$\begin{matrix}{R}_{1} = {w}_{10} + {f}_{1} \cdot w + {ϵ}_{1} \\ {R}_{2} = {w}_{20} + {f}_{2} \cdot w + {ϵ}_{2} \\ Cov ( {R}_{1} , {R}_{2} ) = Cov ( {w}_{10} + {f}_{1} \cdot w + {ϵ}_{1} , {w}_{20} + {f}_{2} \cdot w + {ϵ}_{2} ) \\ = Cov ( {f}_{1} \cdot w , {f}_{2} \cdot w ) \\ = {f}_{1}^{′} Cov ( w , w ) {f}_{2} \\ = {f}_{1}^{′} Ω {f}_{2}\end{matrix} \qquad ( 7 )$$

Thus, the covariance between two bonds is the covariance between the market factors f₁ and f₂ associated with each of the bonds, respectively.

Once the covariance matrix is formed, in Steps 3 and 4, the values for the market factors f₁ and f₂ associated with bond 1 and bond 2, respectively, are determined from various information sources including, by way of non-limiting example, bond rating agencies such as Moodys and Standard and Poors, Bloomberg, Electronic Joint Venture (a provider of bond data and analytics) and other bond information providers.

Finally, in Step 5, the comparability between the two bonds is determined by evaluating how well correlated are the returns for each of the two bonds. The measure of comparability of bond 1 and bond 2 can then be calculated as follows:

$$\begin{matrix}Comparability ( {R}_{1} , {R}_{2} ) = Corr ( {R}_{1} , {R}_{2} ) \\ = \frac{Cov ( {R}_{1} , {R}_{2} )}{σ ( {R}_{1} ) σ ( {R}_{2} )} \\ = \frac{{f}_{1}^{′} Ω {f}_{2}}{\sqrt{{f}_{1}^{′} Ω {f}_{1} {f}_{2}^{′} Ω {f}_{2}}} .\end{matrix} \qquad ( 8 )$$

Thus the comparability of bond 1 and bond 2 only depends on, Ω, the covariance matrix, and the attributes of the bonds in question. Thus, the method for determining comparability of the present invention is not dependent on historical data pertaining to the performance of the bonds in question to determine comparability, as is the case with the prior art techniques. Not requiring historical bond performance for determining comparability makes the method of the present invention especially suitable for evaluating the comparability of new bond issues or issues with little historical data. Furthermore, because the covariance matrix is constructed from market risk factors, it is simple to identify the sources of risk that cause two bonds to be comparable (or not comparable).

In an exemplary embodiment, instead of determining the comparability of two bonds based on the correlation of their respective spreads, comparability may be determined based on the expected volatility in the difference between the spreads of the two bonds. A potential drawback in using spread correlation as an indicator of comparability may arise if the spread volatilities of the bonds being compared vary greatly—for example the spread of one of the two bonds being compared fluctuates between 50 and 100 basis points while the spread of the other bond fluctuates between 10 and 20 basis points. Because the process of correlation eliminates the magnitude of spreads volatility as part of the comparison, if the spread of these two bonds move together, merely correlating the spreads would result in the bonds being found comparable while, in practical terms, the differences in spread value and volatility would make these bonds imperfect substitutes for one another.

In order to take into account the difference in spread value and volatility, comparability is determined by evaluating the volatility of the differences between the spreads of two bonds. In such a case, the bonds are only comparable if their spreads are correlated and their spreads have a similar magnitude of risk. In order to evaluate the volatility of the differences between the spreads of two bonds, a tracking portfolio is formed that consists of a long position in one bond and a short position in the other bond. Thus, any volatility observed in the tracking portfolio, called a tracking error, results from the divergence in the behavior of the two bonds. For example, to assess the comparability of two bonds, represented by factors, f₁ and f₂, a tracking portfolio consisting of a long position in f₁ and a short position in f₂ (or vice versa because comparability is symmetric) is formed. By representing the tracking error of the tracking portfolio as a single factor vector f₁−f₂ and, based on equations (5) and (7) above, the comparability of bond 1 and bond 2 is defined as:

Comparability(f₁,f₂)=Risk_{trackingerror}²=(f₁−f₂)′Ω(f₁−f₂)+δ²(ε) (9)

The result of equation (9), called a comparability quotient, is a measure of the comparability of the two bonds. If the comparability quotient is high (i.e., the tracking portfolio is highly volatile), then the bonds do not track each other well and are therefore highly uncomparable. A low comparability quotient indicates that the bonds are highly comparable while a zero comparability quotient indicates that the bonds exhibit perfectly comparable behavior. In other words, if the two bonds are comparable, then their corresponding factor vectors, f₁ and f₂, are very similar. Consequently, the difference between their corresponding factor vectors, f₁−f₂ approaches zero, and, therefore, the comparability quotient approaches zero. On the other hand, if the corresponding factor vectors, f₁ and f₂, differ substantially, i.e., because the bonds are not comparable, then the difference between their corresponding factor vectors, f₁−f₂ causes the comparability quotient to be high reflecting that the bonds are not comparable.

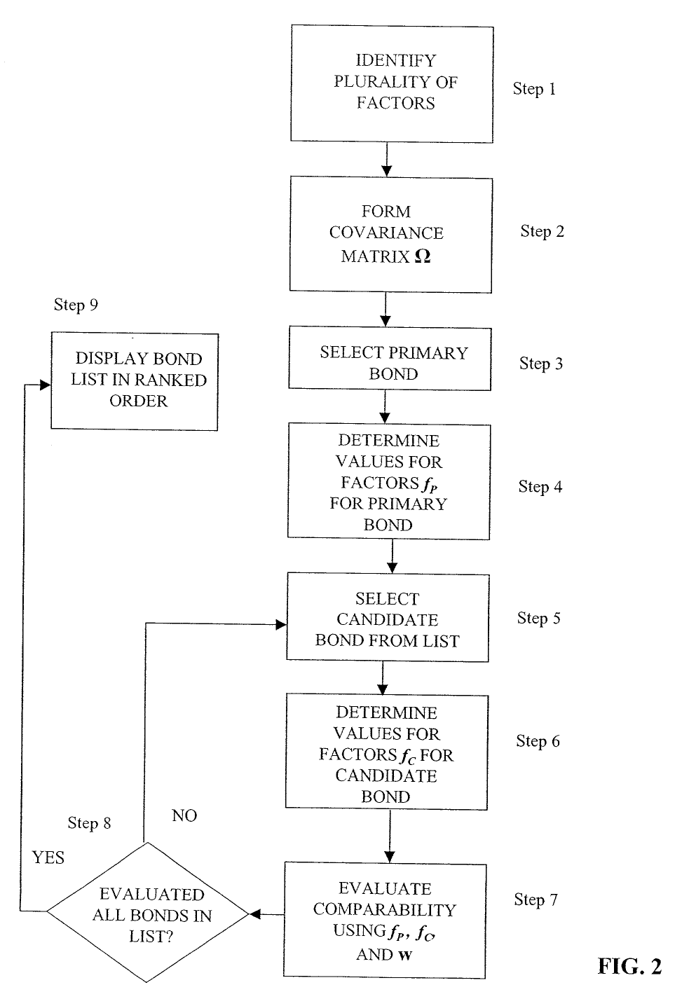

Referring now to FIG. 2, there is shown a flow chart of a method for determining the comparability of a list of bonds to a primary bond. Elements that are similar to elements contained in FIG. 1 are identically labeled and a detailed description thereof is omitted.

Initially, in Steps 1 and 2, a plurality of factors f is identified and a covariance matrix including weighting factors w for each of the plurality of factors f is formed, as described previously. Next, in Step 3, the primary bond for which a list of comparable bonds is desired is selected and, in Step 4, the values of factors fₚ for the primary bond are determined. Next, in Step 5, a candidate bond is selected from the list of bonds and, in Step 6, the values of factors f_{c} for the candidate bond are determined. Next, in Step 7, the comparability between the primary bond and the candidate bonds is evaluated using fₚ, f_{c}, and w according to either Equation 8 or Equation 9. Next, in Step 8, it is determined whether all of the bonds in the list have been compared to the primary bond. If not, then the method returns to Step 5 in which another candidate bond is selected from the list of bonds for comparison to the primary bond. Once all the bonds in the list have been compared to the primary bond, the comparability results of all the bonds in the list are displayed in ranked order.

Table 1 below shows an example of a list of bonds that have been ranked in order of their comparability to a primary bond, WCOM 8.250 05/15/10. The formula used in the example to determine comparability is equation (9) in which B, C, A, E and D are vectors of market factors for Bond P, Bond 1, Bond 2, Bond 3 and Bond 4, respectively. In this case, bond 1, a DT 8.000 06/15/10 is the most comparable to the WCOM 8.250 05/15/10 bond because it has the lowest comparability score. The GS 7.800 01/28/10 bond is the next most comparable bond in the list, followed by the IBM 5.375 02/01/09 and the FNMA 7.125 06/15/10 bonds.

TABLE 1
Comparables for WCOM 8.250 05/15/10

| bond | Formula | Score | name |
|---|---|---|---|
| Bond P: | (B-B)′Ω(B-B) | 0.0000000 | WCOM 8.250 05/15/10 |
| Bond 1: | (B-C)′Ω(B-C) | 0.0000124 | DT 8.000 06/15/10 |
| Bond 2: | (B-A)′Ω(B-A) | 0.0282796 | GS 7.800 01/28/10 |
| Bond 3: | (B-E)′Ω(B-E) | 0.0296883 | IBM 5.375 02/01/09 |
| Bond 4: | (B-D)′Ω(B-D) | 0.0407505 | FNMA 7.125 06/15/10 |

Thus, an investor no longer desiring to hold WCOM 8.250 05/15/10 bonds in a portfolio may replace the WCOM 8.250 05/15/10 bonds with DT 8.000 06/15/10 bonds and expect comparable portfolio performance.

Accordingly, the method of the present invention provides an investor with a list of bonds that are ranked based on each bond's comparability to a primary bond so that the investor can identify bonds that are suitable for adjusting a portfolio or implementing various trading strategies.

In an exemplary embodiment, a tracking portfolio is formed to determine the comparability between a small portfolio of bonds and a large index of bonds, for example, the MSCI Eurodollar index or the J. P. Morgan Government Bond Index. For example, with respect to a portfolio containing two bonds, bond 1 having a return R₁, factor vector f₁, and a market value k₂, and bond 2 having a Return R₂, factor vector f₂ and a market value k₂ the return and risk for the portfolio is defined by:

$${Return}_{portfolio} = {\sum }_{i} {w}_{0 i} + f \cdot w + {\sum }_{i} {ϵ}_{i} \\ {Risk}_{portfolio} = \sqrt{{f}^{′} Ω f + {\sum }_{i} {{σ}^{2} ( ϵ )}_{i}} , \\ where f = {\sum }_{i} {γ}_{i} {f}_{i} \qquad ( 10 )$$

Although Equation 10 describes a portfolio having two securities, because Equation 10 is a linear system, it will be obvious to extend Equation 10 to define the return and risk for portfolios having more than two securities. Thus, the method of the present invention may be used to calculate the comparability between two portfolios by determining the size of the tracking error between the two portfolios.

Furthermore, the present invention may be used to identify a manageable portfolio of bonds that tracks a large index of bonds. To select such a portfolio, a subset of a universe of bonds, for example 20 bonds, is selected and the tracking error between the subset of bonds and the index is calculated. This is repeated until a portfolio of bonds is identified that produces a satisfactorily small tracking error in relation to the index. In this way, the performance of a large index of bonds may be mimicked using a small and manageable number of instruments.

In an exemplary embodiment, the covariance matrix is “tuned” to account for different views of the market or to explore different market scenarios. The covariance matrix is tuned by adjusting the weighting factors associated with the factors represented in the covariance matrix. For example, if bond callability is deemed irrelevant for the comparability analysis in a particular situation, then the weighting factors in the covariance matrix associated with callability are set to zero so that the callability factor has no impact on the comparability calculations. Thus, by adjusting the weighting factors associated with certain market risk factors, the comparability analysis can be tailored for different market situations and viewpoints.

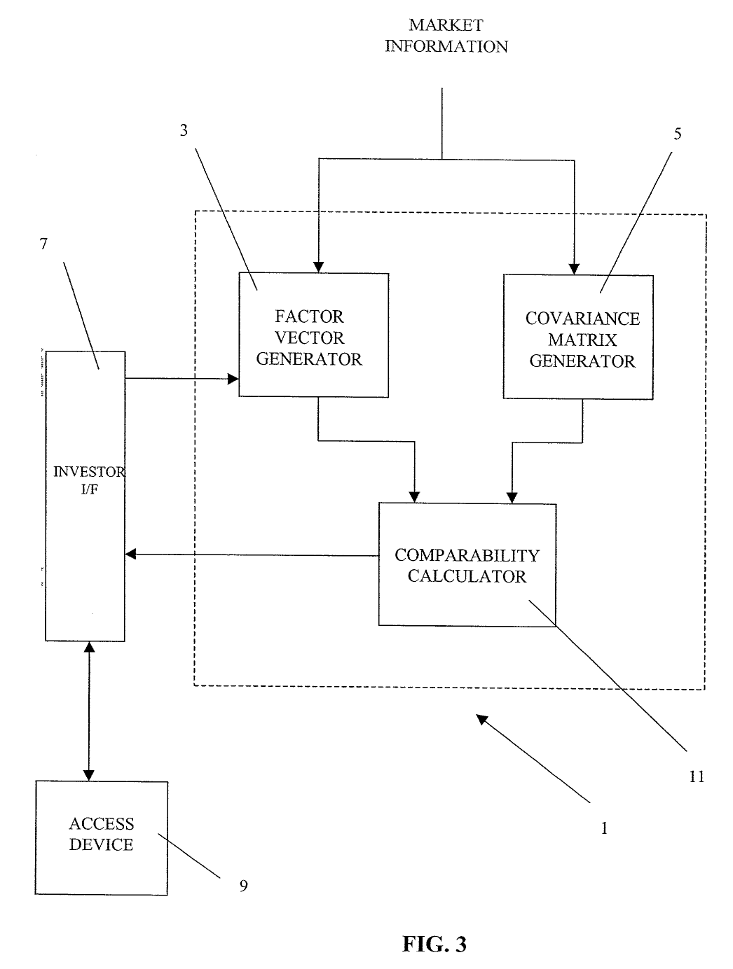

Referring now to FIG. 3, there is shown a block diagram of a system 1 for determining the comparability of instruments, such as bonds. An investor operating an access device 9, that may be, by way of non-limiting example, a personal computer, accesses system 1 via an investor interface 7 for issuing comparability requests and receiving the results of such requests. For example, an investor may request a list of bonds that are comparable to a primary bond. A factor vector generator 3 is included in system 1 for receiving the request from investor interface 7 and, based on market information, determines the values of a plurality of factors fₚ that characterize the primary bond. The sources of market information include, by way of non-limiting example, bond rating agencies such as Moodys and Standard and Poors, Bloomberg, EJV and other bond information providers. Factor vector generator 3 also selects a list of bonds from market information and determines the values of the plurality of factors f_{c} for each of the bonds in the list. System 1 also includes a covariance matrix generator 5 that uses the market information to form a covariance matrix using the steps described above. A comparability calculator 11 receives the factors fₚ of the primary bond, the factors f_{c} of each bond in the list and the covariance matrix and evaluates the comparability of each bond in the list to the primary bond using the method of Equation 8 and/or Equation 9. Comparability calculator 11 then forms a list of comparable bonds in ranked order and provides the list to the investor via investor interface 7 and access device 9.

In an exemplary embodiment, factor vector generator 3, covariance matrix generator 5 and comparability calculator 11 are comprised of computer software executing on a computer system that implements the functions described above. Alternatively, the functions performed by factor vector generator 3, covariance matrix generator 5 and comparability calculator 11 may be implemented by a person possessing the requisite skill or by a combination of computer software and human participation.

Although the above description relates to determining the comparability of bonds, it will be obvious to one of ordinary skill to extend the methods of the present invention to determine the comparability of any other asset classes including, by way of non-limiting example, equities. For example, with respect to equities, the factors used to describe the movement of an equity security may include sector information, volatility, profitability measures, market capitalization and price-to-earnings ratio. Similarly, other suitable factors may be selected depending on the asset class.

Based on the above description, it will be obvious to one of ordinary skill to implement the system and methods of the present invention in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Furthermore, alternate embodiments of the invention that implement the system in hardware, firmware or a combination of both hardware and software, as well as distributing modules and/or data in a different fashion will be apparent to those skilled in the art and are also within the scope of the invention.

It will thus be seen that the objects set forth above, among those made apparent from the preceding description, are efficiently attained and, since certain changes may be made in carrying out the above process, in a described product, and in the construction set forth without departing from the spirit and scope of the invention, it is intended that all matter contained in the above description and shown in the accompanying drawing shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween.

1. A method for determining the comparability of at least two bonds, comprising the steps of:
identifying a plurality of factors associated with said at least two bonds;
determining a value for each of said plurality of factors for each of said at least two bonds;
forming a covariance matrix, said covariance matrix including a weighting factor for each of said plurality of factors wherein each of said weighting factors relates to an amount of market activity attributed to said corresponding one of said plurality of factors;
determining the comparability of said at least two bonds based on said values for each of said at least two bonds and said covariance matrix.

2. The method of claim 1, wherein said values for said plurality of factors for each of said at least two bonds relate to sector information, bond rating information, a duration and a time to maturity.

3. The method of claim 2, wherein said values relate to an issuer country, a put schedule, a call schedule, a sinking fund schedule, a coupon rate and an asset swap spread.

4. The method of claim 1, wherein said market activity are price changes in the market for a previous period of time.

5. The method of claim 4, wherein said period of time is in the range of one week to 1 year.

6. The method of claim 1, wherein the step of determining the comparability includes the step of:
determining the comparability according to:
$$\frac{{f}_{1}^{′} Ω {f}_{2}}{\sqrt{{f}_{1}^{′} Ω {f}_{1} {f}_{2}^{′} Ω {f}_{2}}}$$
wherein f₁ are the values for said plurality of factors for a first of said at least two bonds, f₂ are the values for said plurality of factors for a second of said at least two bonds and Ω is said covariance matrix.

7. The method of claim 1, wherein the step of determining the comparability includes the step of:
determining the comparability according to:
(f₁−f₂)′Ω(f₁−f₂)+δ²(ε)
wherein f₁ are the values for said plurality of factors for a first of said at least two bonds, f₂ are the values for said plurality of factors for a second of said at least two bonds and Ω is said covariance matrix.

8. The method of claim 1, further comprising the step of:
tuning said covariance matrix by adjusting said weighting factor for at least one of said plurality of factors.

9. A method for determining the comparability between a primary bond and each bond in a list of bonds, comprising the steps of:
identifying a plurality of factors associated with said each bonds;
determining a value for each of said plurality of factors for said primary bond and for said each bond in said list of bonds;
forming a covariance matrix, said covariance matrix including a weighting factor for each of said plurality of factors wherein each of said weighting factors relates to an amount of market activity attributed to said corresponding one of said plurality of factors;
determining the comparability between said primary bond and said each bond in said list of bonds based on said values for said primary bond, said values for said each bond in said list of bonds and said covariance matrix.

10. The method of claim 9, further comprising the step of:
ordering each bond in said list of bonds according to the comparability of each bond in said list of bonds to said primary bond.

11. A method for determining the comparability between a portfolio of bonds and an index of bonds, comprising the steps of:
identifying a plurality of factors associated with said portfolio of bonds and said index of bonds;
determining a value for each of said plurality of factors for said portfolio of bonds
determining a value for each of said plurality of factors for said index of bonds;
forming a covariance matrix, said covariance matrix including a weighting factor for each of said plurality of factors wherein each of said weighting factors relates to an amount of market activity attributed to said corresponding one of said plurality of factors;
determining the comparability between said portfolio of bonds and said index of bonds based on said values for said portfolio of bonds, said values for index of bonds and said covariance matrix.

12. Computer executable program code residing on a computer-readable medium, the program code comprising instructions for causing the computer to:
determine the comparability of at least two bonds;
identify a plurality of factors associated with said at least two bonds;
determine a value for each of said plurality of factors for each of said at least two bonds;
form a covariance matrix, said covariance matrix including a weighting factor for each of said plurality of factors wherein each of said weighting factors relates to an amount of market activity attributed to said corresponding one of said plurality of factors;
determine the comparability between said at least two bonds based on said values for each of said at least two bonds and said covariance matrix.

13. The computer executable program code of claim 12, wherein said values for said plurality of factors for each of said at least two bonds relate to sector information, bond rating information, a duration and a time to maturity.

14. The computer executable program code of claim 13, wherein said values relate to an issuer country, a put schedule, a call schedule, a sinking fund scheduler, a coupon rate and an asset swap spread.

15. The computer executable program code of claim 12, wherein said market activity are price changes in the market for a period of time

16. The method of claim 15, wherein said period of time is in the range of one week to 1 year.

17. The computer executable program code of claim 12, wherein the program code additionally causes the computer to:
determine the comparability according to:
$$\frac{{f}_{1}^{′} Ω {f}_{2}}{\sqrt{{f}_{1}^{′} Ω {f}_{1} {f}_{2}^{′} Ω {f}_{2}}}$$
wherein f₁ are the values for said plurality of factors for a first of said at least two bonds, f₂ are the values for said plurality of factors for a second of said at least two bonds and Ω is said covariance matrix.

18. The computer executable program of claim 12 wherein the program code additionally causes the computer to:
determine the comparability according to:
(f₁−f₂)′Ω(f₁−f₂)+δ²(ε)
wherein f₁ are the values for said plurality of factors for a first of said at least two bonds, f₂ are the values for said plurality of factors for a second of said at least two bonds and Q is said covariance matrix.

19. The computer executable program of claim 12 wherein the program code additionally causes the computer to:
tune said covariance matrix by adjusting said weighting factor for at least one of said plurality of factors.

20. A system for determining the comparability between at least two bonds, comprising:
a factor vector generator for identifying a plurality of factors associated with said at least two bonds and determining a value for each of said plurality of factors for each of said at least two bonds;
a covariance matrix generator for forming a covariance matrix, said covariance matrix including a weighting factor for each of said plurality of factors wherein each of said weighting factors relates to an amount of market activity attributed to said corresponding one of said plurality of factors;
a comparability calculator, said comparability calculator receiving from said factor vector generator said values for each of said plurality of factors for each of said at least two bonds, said comparability generator receiving said covariance matrix from said covariance matrix generator, said comparability generator determining the comparability of said at least two bonds based on said values for each of said at least two bonds and said covariance matrix.

21. The system of claim 20 wherein said values for each of said at least two bonds relate to sector information, bond rating information, a duration and a time to maturity.

22. The system of claim 21 wherein said values relate to an issuer country, a put schedule, a call schedule, a sinking fund schedule, a coupon rate and an asset swap spread.

23. The system of claim 20, wherein said market activity are price changes in the market for a period of time.

24. The method of claim 23, wherein said period of time is in the range of one week to 1 year.

25. The system of claim 20, wherein said comparability generator determines the comparability according to:
$$\frac{{f}_{1}^{′} Ω {f}_{2}}{\sqrt{{f}_{1}^{′} Ω {f}_{1} {f}_{2}^{′} Ω {f}_{2}}}$$
wherein f₁ are the values for said plurality of factors for a first of said at least two bonds, f₂ are the values for said plurality of factors for a second of said at least two bonds and Ω is said covariance matrix.

26. The system of claim 20, wherein said comparability generator determines the comparability according to:
(f₁−f₂)′Ω(f₁−f₂)+δ²(ε)
wherein f₁ are the values for said plurality of factors for a first of said at least two bonds, f₂ are the values for said plurality of factors for a second of said at least two bonds and Q is said covariance matrix.

27. The system of claim 20, wherein said covariance matrix is tuned by adjusting said weighting factor for at least one of said plurality of factors.

28. The system of claim 20, wherein said factor vector generator identifies said a plurality of factors and determines said value for each of said plurality of factors for each of said at least two bonds based on market information.

29. The system of claim 20, wherein said covariance matrix generator forms said covariance matrix based on market information.

30. The system of claim 20, wherein said comparability calculator executes on a computer system and further comprising an access device in communications with said computer system for issuing a comparability request to said comparability generator.

31. A method for determining the comparability between at least two instrument, comprising the steps of:
identifying a plurality of factors associated with said at least two instruments;
determining a value for each of said plurality of factors for each of said at least two instruments;
forming a covariance matrix, said covariance matrix including a weighting factor for each of said plurality of factors wherein each of said weighting factors relates to an amount of market activity attributed to said corresponding one of said plurality of factors;
determining the comparability of said at least two instruments based on said values for each of said at least two instruments and said covariance matrix.

32. The method of claim 31, wherein said instruments are equities and said values for said plurality of factors for each of said at least two instruments relate to sector information, volatility, profitability measures, market capitalization and price-to-earnings ratio.

33. The method of claim 31, wherein said market activity are price changes in the market for a previous period of time.

34. The method of claim 33, wherein said period of time is in the range of one week to 1 year.

35. The method of claim 31, wherein the step of determining the comparability includes the step of:
determining the comparability according to:
$$\frac{{f}_{1}^{′} Ω {f}_{2}}{\sqrt{{f}_{1}^{′} Ω {f}_{1} {f}_{2}^{′} Ω {f}_{2}}}$$
wherein f₁ are the values for said plurality of factors for a first of said at least two instruments, f₂ are the values for said plurality of factors for a second of said at least two instruments and Ω is said covariance matrix.

36. The method of claim 31, wherein the step of determining the comparability includes the step of:
determining the comparability according to:
(f₁−f₂)′Ω(f₁−f₂)+δ²(ε)
wherein f₁ are the values for said plurality of factors for a first of said at least two instruments, f₂ are the values for said plurality of factors for a second of said at least two instruments and Ω is said covariance matrix.

37. The method of claim 31, further comprising the step of:
tuning said covariance matrix by adjusting said weighting factor for at least one of said plurality of factors.
